(19) United States
(12) Patent Application Publication
(10) Pub. No.: US 2006/0074550 A1
(43) Pub. Date: Apr. 6, 2006

(54) System and method for distributing multimedia content via mobile wireless platforms

(76) Inventors: Carl Johan Freer, Thursley (GB); Stephen Carroll, St. Albans (GB)

Correspondence Address: Benman, Brown & Williams, Suite 2740, 2049 Century Park East, Los Angeles, CA, 90067, US

(21) Appl. No.: 11/202,859

(22) Filed: Aug. 11, 2005

Related U.S. Application Data
(63) Continuation-in-part of application No. 10/945,271, filed on Sep. 20, 2004.

(51) Int. Cl. G01C 21/30

(52) U.S. Cl. 701/209

(57) ABSTRACT

A system and method for distributing multimedia content to a mobile wireless platform of the present invention. In an illustrative embodiment, the inventive system includes memory for receiving and storing said multimedia content; a controller for automatically transmitting said content; and a wireless platform for automatically receiving, storing and playing out said content. In a specific implementation, the receipt, storage and playback functions are implemented with an applet running on the platform. The content may be transmitted using Global Packet Radio Service (GPRS), Code Division Multiple Access (CDMA) or other suitable network. The applet includes a decoder and code for decompressing said multimedia content. In one embodiment, the system is adapted to transmit multimedia content to a selected mobile wireless platform based on a location thereof. This may be implemented with a GPS receiver or by using cellular position location services. The system includes a server which retrieves data delivery metrics from a database and generates multimedia messages for selected devices accordingly. In the illustrative embodiment, the server generates a schedule file for the playback of the messages and sends messages to the wireless platforms to download the schedule. The schedule file includes a message file address. The applet downloads the schedule file and extracts the message file address. This address is used to download the multimedia message. The message is output in accordance with the schedule. Data relating to the output of the multimedia file is stored for feedback to the server.

### REFERENCE TO COPENDING APPLICATION

This is a continuation-in-part of U.S. patent application Ser. No. 10/945,271 filed Sep. 20, 2004 by Carl Johan Freer and entitled PORTABLE ELECTRONIC DEVICE, the teachings of which are incorporated herein by reference.

### BACKGROUND OF THE INVENTION

1. Field of the Invention

The present invention relates to communication systems. More specifically, the present invention relates to systems for communicating between cellular networks and mobile wireless devices.

2. Description of the Related Art

For many applications, there is a need for a system and method for sending high quality multimedia content to mobile wireless platforms. For example, patent application Ser. No. ______ entitled METHOD FOR ADVERTISING, filed Aug. 11, 2005 by C. Freer (Atty. Docket No. Smart Adds-1) the teachings of which are incorporated herein by reference, discloses and claims a method by which high-quality television type advertisements or (ADDS) are sent to selected handheld wireless devices for playback at a predetermined time based on customer interests and preferences. For this and other applications, there is a need for a system capable of sending high-quality multi-media content to mobile devices.

For such applications, communication to mobile devices is preferred inasmuch as mobile devices (e.g. telephones) are more often with the consumer as opposed to television screens etc. These devices offer a display of rich multi-media content not generally available through any other channel other than television.

Hence, a need exists in the art for a system and method for transmitting high-quality multimedia content to mobile wireless devices.

### SUMMARY OF THE INVENTION

The need in the art is addressed by the system and method for distributing multimedia content to a platform of the present invention. In an illustrative embodiment, the inventive system includes memory for receiving and storing said multimedia content; a controller for automatically transmitting said content; and a platform for automatically receiving, storing and playing out said content.

In a specific implementation, the platform is a mobile wireless platform and the receipt, storage and playback functions are implemented with an applet running on the platform. The content may be transmitted using Global Packet Radio Service (GPRS), Code Division Multiple Access (CDMA) or other suitable network. The applet includes a decoder and code for decompressing said multimedia content.

In one embodiment, the system is adapted to transmit multimedia content to a selected mobile wireless platform based on a location thereof. This may be implemented with a GPS receiver or by using cellular position location services.

The system includes a server that retrieves data delivery metrics from a database and generates multimedia messages for selected devices accordingly. In the illustrative embodiment, the server generates a schedule file for the playback of the messages and sends messages to the wireless platforms to download the schedule. The schedule file includes a message file address. The applet downloads the schedule file and extracts the message file address. This address is used to download the multimedia message. The message is output in accordance with the schedule. Data relating to the output of the multimedia file is stored for feedback to the server.

In the illustrative application, the inventive system is used to send and receive Smart Adds. ‘Smart Adds’ are short multimedia clips that are downloaded and played on a mobile device when appropriate. These clips can be downloaded between specified times and played at between specified times. Downloading of these adverts is transparent to the user and distributed across all users so as not to stress the GPRS networks or servers.

### BRIEF DESCRIPTION OF THE DRAWINGS

FIG. 1 is a block diagram showing an illustrative hardware implementation of a system for multimedia in accordance with the present teachings.

FIG. 2 is a map of the functions provided by the applet in accordance with an illustrative embodiment of the present teachings.

FIG. 3 is a flow diagram of illustrative software running on the controller to effect control of the operation of the system of FIG. 1.

FIG. 4 is a flow diagram of schedule and Smart Add downloading logic in accordance with an alternative embodiment of the present teachings.

FIG. 5 is a flow diagram showing an illustrative implementation of the playback functions.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

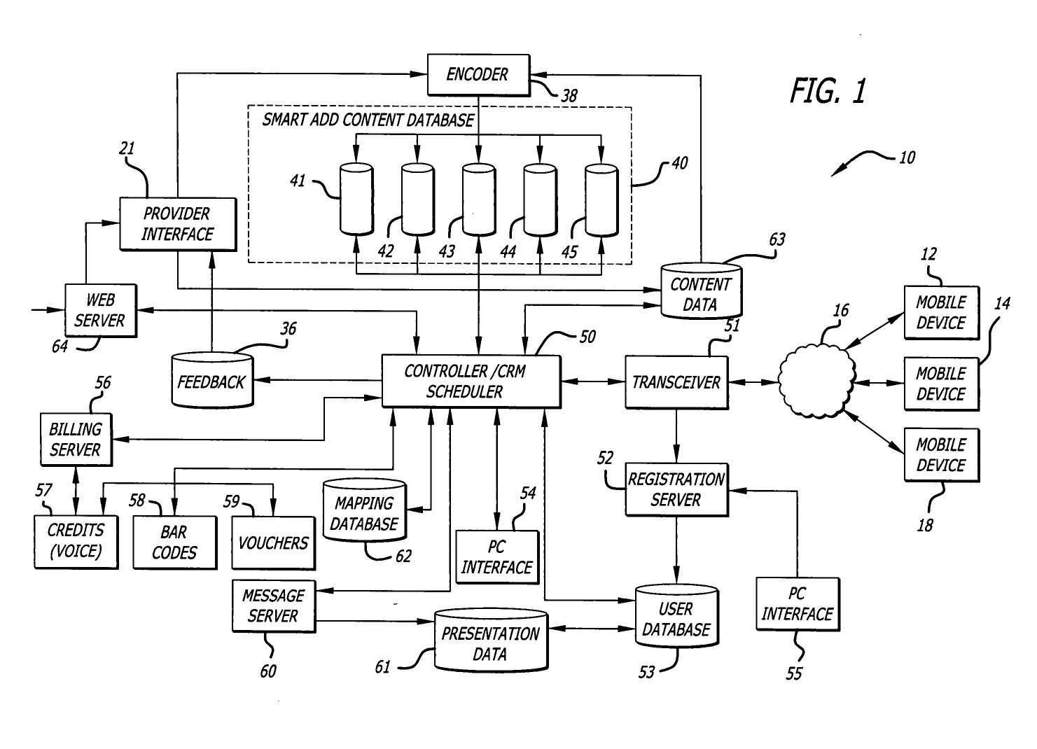

FIG. 1 is a block diagram, which shows an illustrative implementation of a system for distributing multimedia content to mobile wireless platforms in accordance with the teachings of the present invention. As shown in FIG. 1, the system 10 includes an encoder 38, which receives multimedia content via an interface 21. The interface 21 is a provider interface connected to the web via a web server 64. As an alternative, the content may be provided via a disk or other means. The encoder 38 encodes and compresses the content and stores the content in a hub 40. For example, a 10-30 second file might be compressed into 150-300 kilobyte packet. The hub 40 is a storage facility such as a bank of content servers. The hub 40 is shown with five servers 41-45. However, those skilled in the art will appreciate that the invention is not limited to the number of servers used.

The hub 40 is operationally coupled to a controller 50 which, in accordance with the present teachings, serves, inter alia, as a scheduler. In practice, the schedule may be input locally or via the web using a PC interface 54.

The system 10 further includes a feedback database 36 for storing data relating to user responses to the content as discussed more fully below. A registration server 52 is included to store user data (registration and preferences) in a user database 53. This data may be received over the web from users via the user's PC interface 55. An optional billing server 56 is coupled to the controller as well. The billing server 56 also communicates with optional credit, bar code and voucher servers 57, 58 and 59. A message server is coupled to the controller 50 and provides messages related data. A mapping database is included for location-based services as discussed herein.

In accordance with the present teachings, the controller 50 transmits the content via a transceiver 51 to selected wireless mobile platform units 12, 14 and 18 in accordance with a schedule. In the best mode, each unit is a Gizmondo™ handheld communications and entertainment platform. (The Gizmondo is disclosed and claimed in U.S. patent application Ser. No. 10/945,271 filed Sep. 20, 2004 by Carl Johan Freer and entitled PORTABLE ELECTRONIC DEVICE, the teachings of which are incorporated herein by reference.) However, the invention is not limited thereto. While the Gizmondo is preferred because of the powerful and robust design of the device, other devices may be used as well including handheld computers, Personal Digital Assistants, cell phones, etc. Each device unit includes a cellular transceiver, onboard processor (preferably at least 300 Mhz), memory, software (operating system, embedded applications, applet, etc.) display, speakers and a user interface. In addition, a Global Positioning System (GPS) functionality is preferred.

The system uses a complementary service for mobile devices which utilizes the GPS (Global Positioning System) as an embedded or added application. This service provides: user location, the location of the nearest outlet (of the advertiser) in relation to user position and in some instances a turn by turn route direction to the outlet. As an alternative, user position data may be provided by a cellular position location system.

In the best mode, an applet is transmitted to each mobile unit.

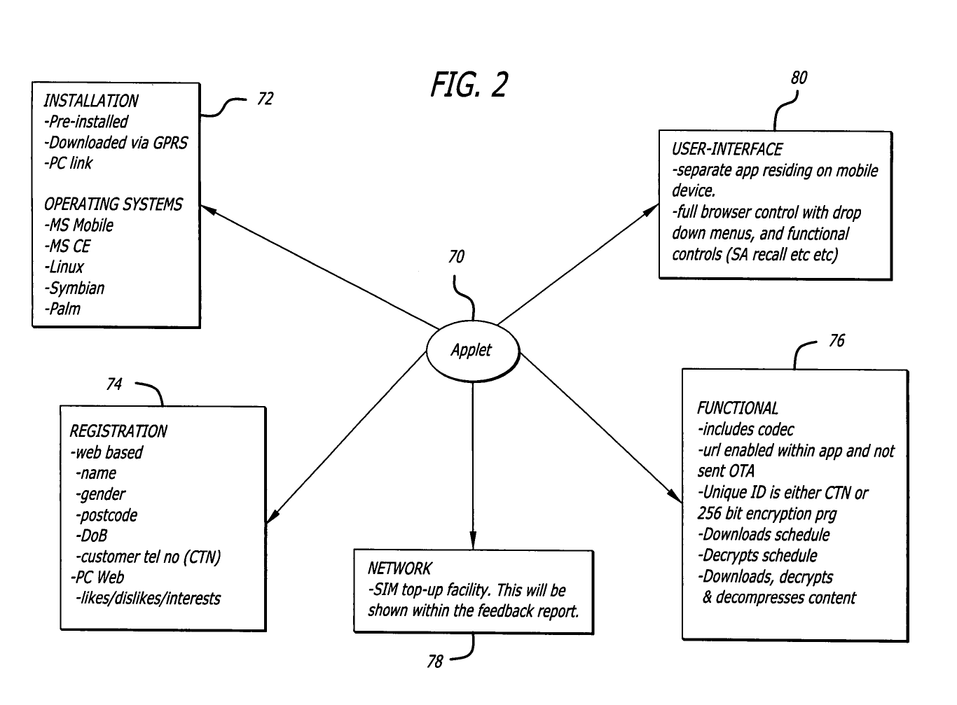

FIG. 2 is a map of the functions provided by the applet 70 in accordance with an illustrative embodiment of the present teachings. The applet 70 is a small program written in C or C⁺⁺ or other suitable program. As shown at 72, the applet 70 may be preinstalled, downloaded OTA via a GPRS, CDMA or other suitable link, or transferred from a PC. The program should be compatible with the operating system of the device (e.g. Windows CE™, Windows ME™, Palm OS™, Symbian™, etc.) and it should include code for decoding and decompressing content received on each mobile device.

In an illustrative embodiment, the applet extracts an XML file which includes a schedule for playback of the content. However, the content may be played out immediately, on demand or command or on the basis of a predetermined set of user inputs. As shown at 74, the applet may be used to upload the original registration detail, e.g., name, DOB, gender, zip/postcode, etc to the server. The applet may be used to communicate technical parameters of the mobile device including operating system, screen resolution and performance. Additional information and preferences can be added through a website.

In the illustrative embodiment, as shown at 76, the applet 70 is provided on an open source codec. As discussed herein, the applet 70 downloads the schedule. The schedule may be requested by each device from the server on a periodic (e.g. daily) basis. In the preferred embodiment, the schedule is an XML file.

Preferably, the content is delivered in either Hypertext Transfer Protocol (http), Hypertext Transfer Protocol Secure (https), File Transfer Protocol (FTP) s it is embodied within Transfer Control Protocol Internet Protocol (TCP/IP) or any other format within the TCP/IP environment.

Before the mobile device is able to receive multimedia messages, the applet is activated either by OTA SMS message from the server which is hidden from the user, or this is specified within the applet itself. Once activated the mobile device will start to periodically check the server for a schedule. This interfaces the applet which wakes the device and retrieves the schedule. Alternatively, the applet could be self-activating or activated based on other conditions without departing from the scope of the present teachings. Preferably, the applet is agile across platforms. As is known in the art, this may be achieved by compilation in the respective operating systems of the target platforms.

In the illustrative embodiment, the content is transmitted via a wireless network provided by a wireless network operator, a Mobile Virtual Network Operator (MVNO) or any other licensed network airtime provider and downloaded on the device 12 (along with the “play-out” instructions) well in advance of the included encoded scheduled play-out time. Those skilled in the art will recognize that this allows the delivery of the content to be staggered relative to the play-out time thereof. The content can thus be timed to play-out simultaneously, at a particular time in a local or predetermined time zone, or at a relative time based on user activity.

Any suitably fast network may be used to transmit the content. In GSM (Global System for Mobile Communications) networks, the applet and the ad may be transmitted using GPRS (General Packet Radio Service).

See http://www.gsmworld.com/technology/gprs/intro.shtml#1.

GPRS, also called 2.5 G, builds on existing second generation GSM networks and is well suited for the delivery of Smart ADDS. However, the present method may be implemented in 3G CDMA (Code Division Multiple Access) or WCDMA (Wideband CDMA) or TDMA (Time Division Multiple Access) networks without departing from the scope of the present teachings.

The content is transferred through these cellular networks and is adaptable to any other popular PCS system and, after receipt, merely sit in the target mobile device's memory until playback.

The operation of the invention will now be provided with respect to an illustrative advertising application. Nonetheless, those of ordinary skill in the art will appreciate that the present teachings may be utilized for other content distribution applications without departing from the scope of the present teachings.

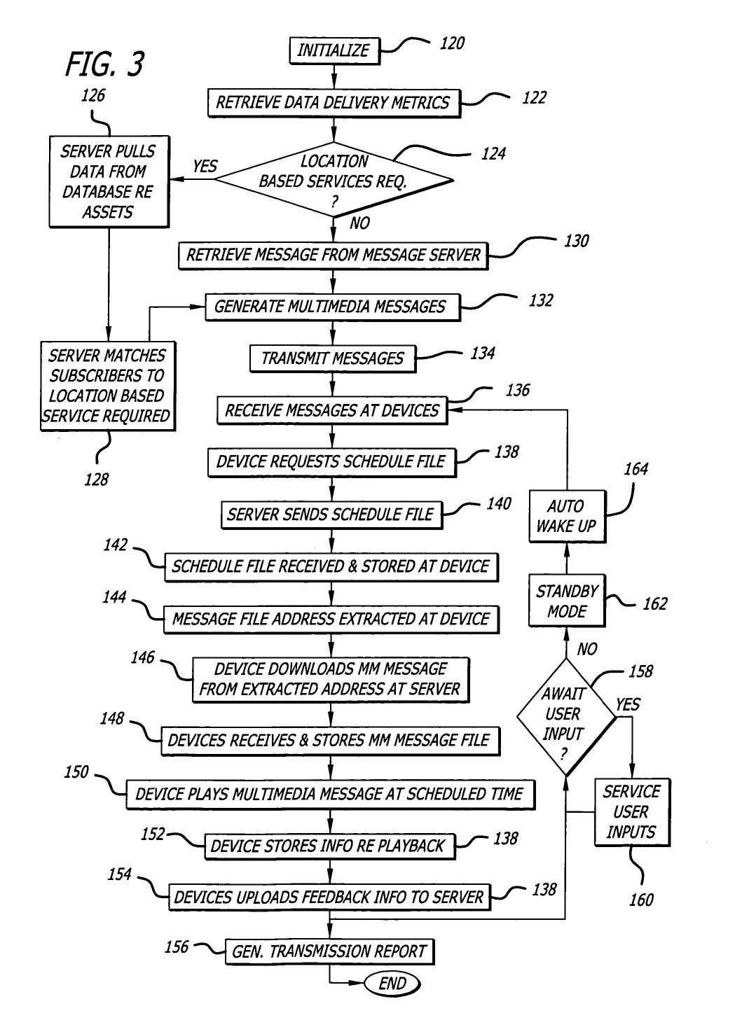

FIG. 3 is a flow diagram of illustrative software running on the controller to effect control of the operation of the system of FIG. 1. As shown in FIG. 1, a message server 60 is connected to controller 50 either directly or via a network. As illustrated in FIG. 3, in accordance with the method 100, at step 122, the message server 60 accesses a database of message delivery metrics defining the selection and timing of multimedia messages to be sent selectively to each device of a set of devices served by the controller 50. Each device may alternatively receive and store one or more multimedia messages with a separate schedule file which is processed by the messaging module to present messages a predetermined times according to the schedule. At step 124, the system checks to see if location based services are requested. If so, at step 126, the server pulls data from a database 53 of mobile platform assets. At step 128, the server then matches subscribers to location based service requests and moves to step 132.

If, at step 124, location based services are not requested, then at steps 130 and 132, the controller 50 accesses a database 63 of content data for a number of content providers (e.g. advertisers) to enable individual message files to be generated such that, for example, each message file contains a video clip specific to a given provider. The message server 60 accesses a database of presentation data 61, the presentation data defining the manner in which the video clips are presented in terms of style, logos specific to the multimedia message provider and the control unit. In order to initiate a set of one or more multimedia messages being delivered to a device, the server sends a single SMS message to that device (step 134). The mobile device receives the SMS message which is a notification providing an address on the server of a schedule file. In the preferred embodiment, the SMS message is sent at the time of registration. The server need not continuously send out SMS messages to initialize a schedule download. As an alternative, the download address may be stipulated and subsequently loaded onto the device at the point of installing the applet.

The messages are received at step 136 and at step 138, each device responds to the notification by initiating a GPRS session via the mobile network to request the schedule file. In response, at step 140, the server sends the schedule file via GPRS to be received and stored in the mobile device (step 142).

As discussed above, the schedule file is an XML file containing details of a set of one or more multimedia message files, including for each message file the address in the server at which the message file can be accessed. This address is extracted at step 144 and used at step 146 to download the message from the server (step 148). In the illustrative embodiment, the device requests the multimedia message file via GPRS. The message is then transmitted by GPRS to the mobile device where it is received and stored (step 148).

At step 150, the mobile device plays the message file in the manner defined in the schedule file. This may involve playing the message file at predefined intervals over a period of one or more days until such time as an expiry time for the message file is reached. When an expiry is detected, the message file is deleted.

The display of the multimedia message is preferably controlled so that a currently played game or movie is not interrupted but that as soon as it is finished the mobile device user is invited to view the multimedia message and further use of the entertainments function of the mobile device are inhibited until the multimedia message has been displayed.

Successive data fields of the file are set out as follows:
The version of XML schedule file is indicated. The device periodically requests updates to the XML file so that it is appropriate for the current issue of schedule file to be identified by a value representing the file version.
An XML tag, e.g., “Smart Add” defines an address from which the message file can be downloaded.
A “file name” field provides the name of the file containing the multimedia message.
A “start time” field indicates the earliest time at which the message file is to be played, in other words the starting date and time from which delivery of the multimedia message is to commence.
Similarly, an expiry time is indicated, providing the last date and time at which the multimedia message is to be delivered, and triggering the deletion of the message file.
A “play type” field defines the earliest opportunity after the “start time” the content can play.
A “repeat count” field defines the number of times that the message can be repeated before being deleted.
A “repeat time” field defines the number of minutes between repeat message play.
An “order” field defines a hierarchical order between competing multimedia message files, the message file having the highest order being played in preference to those having a lower order as defined in the field value contained in the XML file.

In the illustrative embodiment, the use of the schedule file provides efficient management of multimedia message files and requires only a single SMS message via the mobile network to initiate a succession of multimedia messages, the downloading and playing of the message files being controlled by the XML files, successive versions of which are received by the mobile device. In the illustrative embodiment, the mobile device will automatically check the server within the specified time window to ascertain if there is a new schedule to download. As an alternative, the schedule may include data regarding the time at which the next schedule is to be retrieved or a schedule update may be pushed to the device using an OTA/SMS command. In exceptional circumstances, a further SMS message may trigger the downloading of a new schedule file when it is required to restructure the payback of multimedia messages with immediate effect.

An alternative embodiment provides a multimedia message that plays out immediately or requires user interaction via the user interface, as in the case of a competition or survey. In the latter case, the message could take the form of an application session which ends when all required user responses have been received.

Multimedia messages relating to a product or service available at a specific location may be targeted to devices whose position is determined to be in the immediate locality or within a specified radius.

If the server receives a demand for such localized multimedia messages to be generated, for example from multimedia message provider. The server refers to a database which contains details of each of asset of devices currently operating in the system and matches subscriber information for each device with details of the multimedia message in order to select a subset of devices which are eligible to be targeted with the multimedia message.

This matching process may contain a number of stages, commencing with an initial step of determining whether, for each device, the subscriber has opted to receive such multimedia messages. Where the subscriber has agreed to receive a specified number of multimedia messages within a given time period, for example 12 messages a day, the history of sending previous multimedia messages needs to be checked to ensure that the number of messages sent does not exceed the allowed number. Similarly, the subscriber may have agreed to accept messages at certain times or certain days of the week and this information is compared with the current demand for the multimedia message.

The resulting subset represents those devices for whom the subscriber has agreed to accept a message and for which the currently demanded multimedia message can be delivered in accordance with an agreed schedule for each subscriber. Further filtering may rely upon matching features of the advertisement with preferences of the subscriber, such as interest in sport, music and games.

At step 124, when location data for each device of the subset is requested, the server sends to each device a message requesting an indication of the current position of the device. The device responds with position data from its GPS software module, thereby enabling the server to accumulate position data for each device in the subset. The position criteria for the received demand for localized multimedia messages are then used to filter the subset so that for example where the localized multimedia messages are required within a one mile radius of a retail outlet with a promotion for a specific product, those devices identified from their position data as being outside of the one mile radius will be excluded from the subset, thereby providing a filtered subset of devices in the required location.

This request may be initiated by the mobile device instead of originating at the server. That is, in this case, when the user selects ‘find my nearest’, the device will update its GPS position and send this data to the server via the GPRS connection. In doing so, it will send the latitude and longitude to the server. The mapping server 62 then provides a map, route and other Location Based Services based upon the users position and requested outlet. The server in return will send a map image and routing information to the mobile device. At this point, the device opens a web browser and displays the map and routing information.

Multimedia messages are provided to each device of the filtered subset. In this embodiment, an SMS message is transmitted to each device of the filtered subset, the message containing the URL (Universal Resource Locator) at which a schedule file and then the multimedia message can be downloaded via the Internet using the procedures described above. The multimedia message downloaded by the device may typically be a file of size 2-300 k containing the multimedia message in the form of a video clip. The device user may then be invited to download a map showing the location of the outlet.

The multimedia message may also include a redeemable token which can be exchanged at the retail outlet for a discount or promotional offer. The token may be in the form of machine readable indicia such as a barcode which can be displayed at the point of sale and scanned by a conventional barcode reader, so that to redeem the token the device user simply presents the device at the point of sale where a barcode reader is used to read the barcode displayed in the display screen of the device. Hence, for this application, the display screen should have sufficient display resolution for barcode to be reliably detected.

The server, map data provider and multimedia message provider together comprise a control system for providing multimedia messages. These entities may be located separately and linked by networks or may be co-located as a single entity, and may comprise one or more processing units such as server computers.

In an alternative embodiment, the server sends the multimedia message directly to the device. Other messaging protocols may be used where appropriate.

In an alternative arrangement, an initial step of determining the approximate location of each device by obtaining cell identification information from the mobile network, such information being generally available when the device is registered with the mobile network and receiving signals within one of the cells of the cellular network. The position information available is less specific than available via the GPS data of the device itself but can be used to initially reduce the subset of devices under consideration, thereby reducing the number of messages which need to be sent in a second step in order to obtain the GPS position data from each device.

The system may select a subset of devices for receiving an advertisement message by comparing an advertisement profile representative of content of the advertisement with subscriber information in respect of the device. Candidates can then be selected for receiving the multimedia message if the multimedia profile matches the subscriber information. For example, a subscriber who is known to be interested in sport may receive sports promotional material and a subscriber who has indicated a preference not to receive advertisements relating to motor vehicles may be excluded from receiving such material.

Selection of the basis of subscriber profile may be used in combination with selection on the basis of current location of the device, or alternatively the selection may be made independently of any position information.

Preferably each device stores in memory a record of each time the advertisement message is viewed together with the current location of the device at the time of viewing, the time at which the viewing occurred and any other information which may be of interest to the advertiser. This information is uploaded to the server and processed for use by the advertisement message provider; the upload of such data may occur at the same time that a schedule file is received.

At step 156, the advertisement message provider may then extract from the log for each device viewing profile data representative of the advertisement viewing history of the subscriber associated with the device. This information may be used in refining the targeting of further advertisement messages or for other purposes. The information may be collected for subsequent analysis as to the number of advertisement messages sent, the identity of each device user receiving a multimedia message, whether or not the advertisement was successful in inducing the device user to go to the specified location, and whether the barcode was used to take advantage of the special offer. This collected information may then be formatted in appropriate metrics to be provided to the advertiser as feedback for use in subsequent multimedia campaigns.

The log of information for each device may also be used to reward the device user. For each instance of viewing an advertisement message, the device may be allocated a credit so that by accumulating credits for multiple viewings of advertisement messages the amount of accumulated credits can be used as a basis for awarding the user.

In one embodiment, the system includes an accounting system which administers a subscriber account in which such credits reduce the amount debited to the subscriber in relation to use of telecommunications services. The subscriber may for example have a prepaid subscription account for mobile telephone calls and by accumulating credits may obtain discounted or free use of such calls.

Other rewards may be in the form of tokens redeemable at the point of sale, such tokens being transmitted for display on the device, for example as a bar code.

A business model for use of such a system can therefore be constructed so that the device user has minimal expenditure. Multimedia entities wishing to have advertisement messages delivered to a device may pay an amount for each message delivery instance ad in return will receive information extracted from the user log to confirm when and where the message was delivered and to which subscriber. The device user on the other hand could be rewarded such that for example for agreeing to watch ten advertisement messages per day the device could be provided at reduced or zero cost.

For example:

| Example situation | Action |
|---|---|
| Device is left overnight | Smart Add Schedule downloaded |
| in its ‘standby’ state | Smart Add(s) specified in schedule are |
| | downloaded |
| Device is turned on | Smart Adds played back when appropriate |
| next day | to user |

Three types of OTA messages can be sent to the mobile device to control Smart Adds. All download locations are set by a link set in the shell configuration. An example of this could be:
address: http://www.SmartAddds.com/download/?
   This address can be updated by the use of an OTA message. The message contains the new address that should be used for downloading and uploading of feedback information, this adds future flexibility and locale specific configuration if necessary.

If schedules need to be updated with immediate effect, the following types of OTA configuration messages can be sent:
Delete a specific Smart Add before playback
   One or more specific Ads can be referenced (if space is available in the OTA message)
Delete all remaining Adds and force a update of the schedule
   New Smart Adds could then be downloaded regardless of the current local time
      Schedule Downloading

The schedule file specifies the Smart Add(s) to download, information such as when to download, and when to playback, special instructions about playback and expiry information are included.

The download location for the schedules is a preset location based on the download address. This will be called the Smart Add Schedule Address and can be changed by resending the OTA message to configure the download location. An example of this address could be: 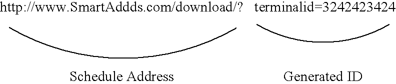
The ‘ID’ tag is a unique ID of an assigned mobile device after running through a basic encryption mechanism.

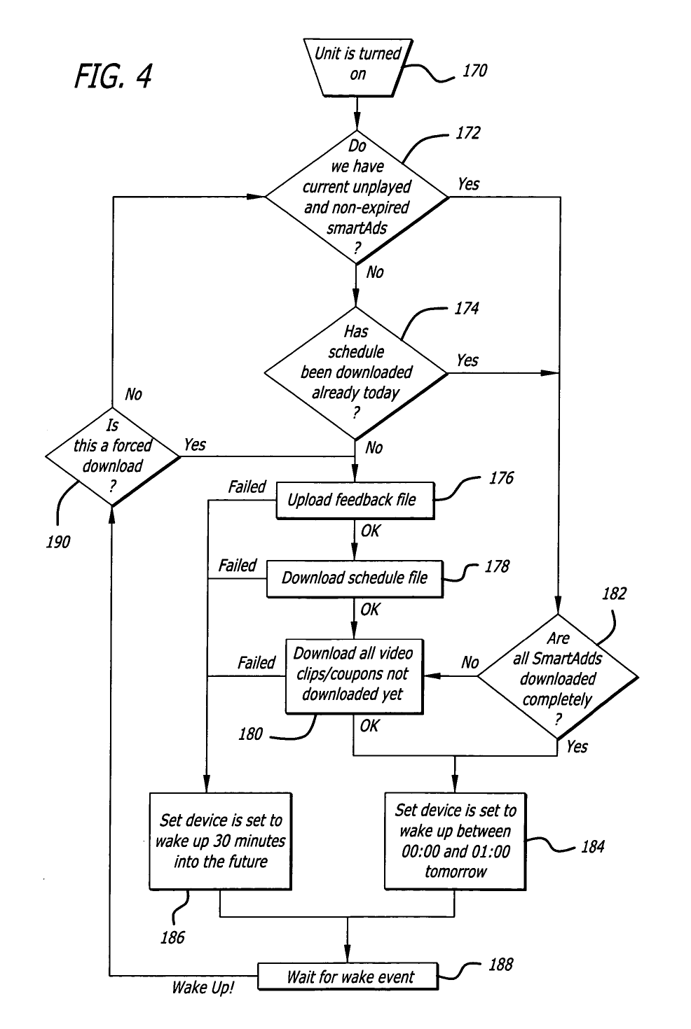

FIG. 4 is a flow diagram of schedule and Smart Add downloading logic in accordance with an alternative embodiment of the present teachings. In this embodiment, the schedule information file is retrieved once per day (step 170-174) with the flight mode disabled Flight mode disables all modem functionality. Therefore, if the mobile device has flight mode enabled, users will not receive any Smart Add's as well as SMS, MMS, voice calls, GPRS etc. Flight mode functionality is available on many modern phone types. (unless there are unplayed Smart Adds still pending). At steps 176-180 (even numbers only) the unit uploads a feedback file, downloads a schedule file and downloads the multimedia content respectively. The unit may retry every 30 minutes, for example, until downloading is complete. Once complete the unit sets its wake up timer for the next day.

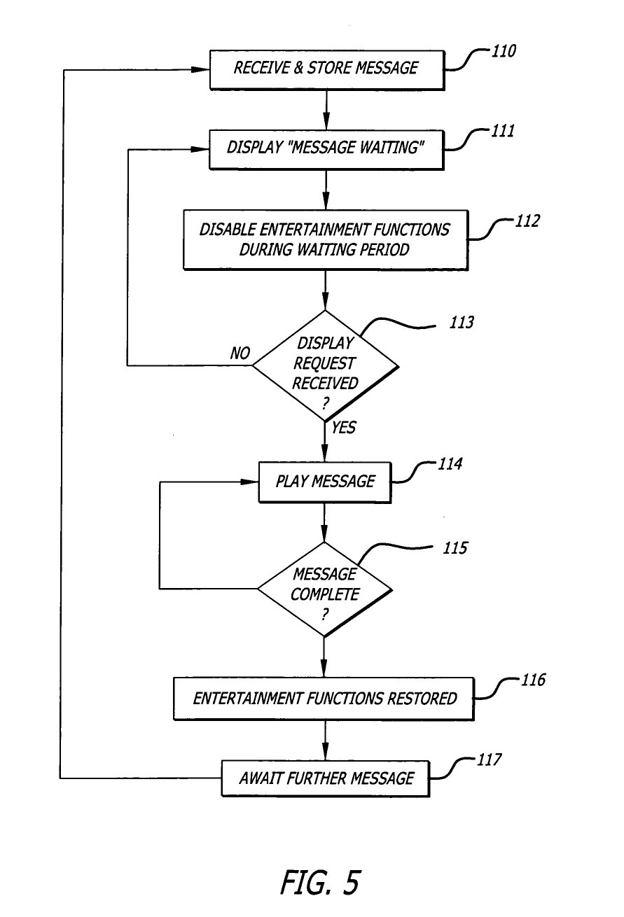

FIG. 5 is a flow diagram showing an illustrative implementation of the playback functions. In this implementation, after a message is received and stored (step 110), a “message waiting” indicator is displayed (step 111). The entertainment functions are then disabled (step 112) and the unit waits for a display request (step 113). On receipt of the request, the unit plays the multimedia message (step 114). When the message is complete, the entertainment functions are restored (step 116).

Schedule XML Interface

In the illustrative embodiment, the schedule information is contained within an XML file. Illustrative valid attributes and values with their working descriptions are given below:

| XML Theme | | |
|---|---|---|
| Attributes | Values | Description and Usage |
| version | 1 | Describes the version of |
| | | XML Schedule being downloaded |
| minBackToBack | default 30 | Specifies the minimum |
| | | time in minutes between |
| | | Smart Add being able to play. |

| XML Tags | Description and Usage |
|---|---|
| SMARTADD | Describes the XML node for a smart Ad |

| Smart Add | | |
|---|---|---|
| XML | | |
| Attributes | Values | Description and Usage |
| Id | Integer | Id of the smart add for playback identification |
| Filename | ftp/http/https link | Absolute link of file to download, i.e. |
| | (wmv movie file) | http://www.SmartAddds.com/dnloadad1.wmv |
| Coupon | ftp/http/https link | Absolute link of file to download, i.e. |
| | (jpg/gif coupon file) | http://www.SmartAddds.com/coupon1.jpg |
| Link | http/https web link | Absolute link to web site |
| | | http://www.SmartAddds.com/ad1.html |
| playStartTime | day/month/year@hr:min | Earliest time that the Smart Add should be played. |
| | | I.e. |
| | | 16/04/2004@07:30 |
| playExpireTime | day/month/year@hr:min | Latest time that the Smart Add should be played. |
| | | i.e. 16/04/2004@16:30 |
| playType | normal | Smart Add is played at the earliest opportunity after |
| | | playStartTime (optional, default = normal) |
| Priority | 0 . . . n | Order of smart ad playback, higher order Ads will be |
| | | played in preference to lower order Smart Adds |
| | | (optional, default 0) |

<THEME version=″1.0″>

<SMARTADD id=”110113” filename=″http://www.SmartAddds.com/dnloadad1.wmv″

coupon=”http://www.SmartAddds.com/coupon1.jpg”
link=”http://www.SmartAddds.com/ad1.html“ playStartTime=16/04/2004@07:30
playExpireTime=”16/04/2004@16:30” Priority=”0”></SMARTADD>

<SMARTADD id=”110120” filename=http://www.SmartAddds.com/dnloadad2.wmv

playStartTime=16/04/2004@07:30 playExpireTime=”16/04/2004@16:30”
Priority=”1”></SMARTADD>

</THEME>

Multimedia content will playback between the times specified in the playStartTime and playExpireTime XML tags.

The content is prioritized by the order tag, higher order content is played before lower order content if more than one message is valid for a given time.

The content can be deleted after it is played. As an alternative, the content may be forwarded from one device to another (peer-to-peer) using Bluetooth, infrared or other functionality. Where appropriate, and as an alternative, the URL (User Record Locator) only of the content (e.g. the Smart ADD) may be forwarded from one device to another. This is particularly advantageous where the devices are dissimilar as it would allow a version to be downloaded from a server that is optimized for the receiving device.

The minimum time between playback of Smart Adds can be specified in the XML theme header of the schedule using the minBackToBack tag; otherwise a predetermined, e.g., 30 minute minimum, back to back playback may be assumed. This is used when two or more ads are available to play at the same time. This rule stops immediate playback of the second ad after the first has played.

In the illustrative embodiment, valid Smart Adds will play when the user navigates to the home screen (this is the top most menu). When a Smart Add is downloaded/played/stored a log of this information is stored on the device. In the illustrative embodiment, before the next schedule is downloaded this information is posted to the server.

The schedule file is in XML form, for example:

| XML Theme | | |
|---|---|---|
| Attributes | Values | Description and Usage |
| Version | 1 | Describes the version of XML Playback |
| | | information being uploaded |

| XML Tags | Description and Usage |
|---|---|
| SCHEDULE | Describes the XML schedule information |
| SMARTADD | Describes a particular Smart Add and an action |
| | performed |
| UNIT | Describes specific unit information |

SMART ADD Tags

| XML | | |
|---|---|---|
| Attributes | Values | Description and Usage |
| Id | 0 . . . n | Id of the smart add, corresponding |
| | | to the id specified in a |
| | | previous schedule XML |
| Action | 0 . . . 2 | 0 = downloaded |
| | | 1 = played and discarded |
| | | 2 = played and saved |
| actionTime | UTC | Time of action |
| gpsLong | Degrees | Location of action |
| gpsLat | Degrees | Location of action |

Schedule Tags

| XML | | |
|---|---|---|
| Attributes | Values | Description and Usage |
| downloaded | UTC | Time of schedule download |
| gpsLong | Degrees | Location of unit during download |
| gpsLat | Degrees | Location of unit during download |

Unit Tags

| XML | | |
|---|---|---|
| Attributes | Values | Description and Usage |
| TerminalID | 8 Bytes | TerminalID |

Once the Smart Add application is installed the registration process will be executed. This process opens a web browser with the server; the user is walked through a series of pages that will cover:
Users details (Name, date of birth, gender, Postcode etc),
user's preferences (Likes/Dislikes)
Mobile device selection
Legal information

In the illustrative embodiment, a unique serial number is generated in the registration process to identify the mobile device and SIM combination. This is used to identify the targeted Smart Add mobile device. At the point of purchasing the device, the purchaser is invited to accept an option to undertake to receive a schedule of multimedia messages which may for example be limited to a specific number of messages per month.

Preferably, the registration process is web based and therefore can be tailored for different mobile device display outputs. In the illustrative embodiment, after mobile device registration the network will know the following basic facts of the mobile device:
a unique registration number
the exact phone and OS running on the mobile device
screen requirements
video codec requirements
audio codec requirements

The user may then be invited to visit a web site and provide information on their entertainment interest. When the user logs into this web page, they give their user name and password—which then links their responses back to their unique serial number and thus to the initial registration information. This allows for a segmentation of those users who provide this information by entertainment interests, as well as their gender/age/home location gathered from the terminal registration.

At predetermined intervals, e.g., once every 24 hours, within a specified ‘window’ (programmed to start in the middle of the night), each mobile device automatically queries the server. This occurs if the mobile device is either in ON or STANDBY mode. If the mobile device is turned OFF, it will either turn on and access the server or access the server the next time it is turned ON (what ever the time of day that happens to be). It will continue to download the schedule periodically, e.g., every 30 minutes, until it has successfully downloaded to the mobile device.

If there is a Smart Add scheduled to be served to the mobile device, there will be an XML file ready for it to download. The XML file downloads. It contains the transmission schedule for that mobile device (ad type, play time). The schedule can be as far in advance as we choose to make it (the next week's ads or just the next day's ads).

Once the schedule has been downloaded the Smart Adds themselves are downloaded over GPRS and stored on the device. Where to download the Smart Add content from is detailed in the schedule file, these can be any FTP/HTTP/HTTPS addresses.

Example: An ad has a play-out window of 09:00 to 12:00 the next day. At 09:00, the mobile device makes a “bleep”—the sound of a text message arriving. If the mobile device is on the main menu page, then the next button that the user has to press is the “play message” button. No button works until it is pressed. The ad has to play through completely (again no button works). If at 09:00 in this example, the user was doing something on the mobile device (sending a text/listening to music etc) then they get the text alert sound—but are not disturbed in their activity. However, when they next go back to the main menu, or if they try to turn off the mobile device, they find they have to play the message/ad first—and no other buttons work until it has played through.

The mobile device then provides an indication to the device user that a message is awaiting viewing. In this embodiment, the mobile device indicates to the user it has received a multimedia message file and generates output data causing the display screen to display a notification message. The mobile device then waits to receive input from the device user via the control pad as an instruction to display the message. While the advertisement is playing, the entertainment functions of the mobile device are temporarily disabled. These functions include the ability to play games, playback video and audio material, and provide any other entertainment features of the mobile device.

The device user is thereby presented with the multimedia message in the form of a video clip, audio clip, or other formats such as animated graphics. When it is determined that playback of the multimedia message has been completed, the entertainment functions of the mobile device are fully restored and further messages are awaited. This temporary interruption of availability of entertainment function provides an incentive to ensure the multimedia message is delivered to the device user.

Once the ad has played through the mobile device, the user has the option of saving the ad, coupon and web-link. If there are numerous ads scheduled to play within the same window, the illustrative configured 30 min play back-to-back configuration is set as default. This can be configured per schedule.

In accordance with the present teachings, feedback is produced to provide information on all aspects of the Smart Add process. For example, the next time the mobile device logs into the server it reports back on:
Registration information of mobile device
Previous schedule download time
Each Smart Add download time and success information
Playback of each Smart Add
Played ok (including time of playback)
Expired before playback could be attempted
Users action regarding Smart Adds
Smart Add was saved for future viewing
Smart Add was discarded after playback
Smart Add was viewed again

This data is provided in a transmission report, generated from server. The process should be invisible to the user.

In the best mode, the devices are equipped with receivers responsive to signals from Global Positioning System (GPS) Satellites for determining the position of the device, the GPS data being used for location and direction purposes. For users of these devices, if the advertiser has a “find my nearest store” option at the end of the ad, the user is provided with a capability to see store listings preferably with a couple of button clicks.

The “find my nearest” facility ascertains the users current location position and routes them to their chosen store. The solution provides this information with map and/or turn-by-turn directions. The solution might be:
Exit the ad, and select “GPS and web services”
There would be a separate folder called “Smart Adds advertiser locations”
In that folder the advertisers are in alphabetical order.
Select the advertiser.
That selection (behind the scenes) links to the Map Info database, and calls up the map.

Thus, the present invention has been described herein with reference to a particular embodiment for a particular application. Those having ordinary skill in the art and access to the present teachings will recognize additional modifications, applications and embodiments within the scope thereof. For example, the content may be transmitted to a stationary device or wired device without departing from the scope of the present teachings.

It is therefore intended by the appended claims to cover any and all such applications, modifications and embodiments within the scope of the present invention.

Accordingly,

What is claimed is:

1. A system for distributing multimedia content comprising:
means for receiving said multimedia content;
means for automatically transmitting said content; and
means for automatically receiving, storing and playing out said content on a platform.

2. The invention of claim 1 wherein said platform is a mobile wireless platform.

3. The invention of claim 1 wherein said means for automatically receiving said content includes an applet.

4. The invention of claim 3 wherein said applet includes a decoder.

5. The invention of claim 4 wherein said applet includes code for decompressing said multimedia content.

6. The invention of claim 3 wherein said applet is adapted to run on more than one operating system.

7. The invention of claim 1 further including means for transmitting content to a selected mobile wireless platform based on a location thereof.

8. The invention of claim 7 wherein said means for transmitting content to a selected mobile wireless platform based on a location thereof includes GPS receiver.

9. The invention of claim 7 wherein said means for transmitting content to a selected mobile wireless platform based on a location thereof includes means for utilizing location information from a cellular network.

10. The invention of claim 1 further including means for retrieving data delivery metrics.

11. The invention of claim 10 further including means responsive to said metrics for generating multimedia messages.

12. The invention of claim 11 further including means for transmitting said messages.

13. The invention of claim 1 further including means for transmitting a schedule file.

14. The invention of claim 13 wherein said applet includes means for receiving said schedule file.

15. The invention of claim 14 wherein said schedule file includes a message file address.

16. The invention of claim 15 further including means for automatically downloading a multimedia message from said address.

17. The invention of claim 16 wherein said multimedia message is downloaded using Transfer Control Protocol Internet Protocol (TCP/IP).

18. The invention of claim 16 further including means for transferring said multimedia content from one mobile platform to another mobile platform.

19. The invention of claim 18 wherein said means for transferring said multimedia content from one mobile platform to another mobile platform includes means for transferring an address of said content.

20. The invention of claim 16 wherein said applet includes means for playing out said message in accordance with said schedule.

21. The invention of claim 20 further including means for feedback of data relating to said playing out of said message.

22. The invention of claim 21 further including means for generating a transmission report.

23. The invention of claim 1 further including automatically waking said mobile wireless platform.

24. A system for distributing multimedia content to a mobile wireless platform comprising:
memory for receiving and storing said multimedia content;
a controller for automatically transmitting said content;
a wireless platform; and
an applet disposed on said platform for automatically receiving, storing and playing out said content.

25. The invention of claim 24 wherein said content is transmitted using Global Packet Radio Service (GPRS).

26. The invention of claim 24 wherein said content is transmitted using Code Division Multiple Access (CDMA).

27. The invention of claim 24 wherein said applet includes a decoder.

28. The invention of claim 27 wherein said applet includes code for decompressing said multimedia content.

29. The invention of claim 27 wherein said applet is adapted to run on more than one operating system.

30. The invention of claim 24 further including means for transmitting content to a selected mobile wireless platform based on a location thereof.

31. The invention of claim 30 wherein said means for transmitting content to a selected mobile wireless platform based on a location thereof includes GPS receiver.

32. The invention of claim 30 wherein said means for transmitting content to a selected mobile wireless platform based on a location thereof includes means for utilizing location information from a cellular network.

33. The invention of claim 24 further including means for retrieving data delivery metrics.

34. The invention of claim 33 further including means responsive to said metrics for generating multimedia messages.

35. The invention of claim 34 further including means for transmitting said messages.

36. The invention of claim 24 further including means for transmitting a schedule file.

37. The invention of claim 36 wherein said applet includes means for receiving said schedule file.

38. The invention of claim 37 wherein said schedule file includes a message file address.

39. The invention of claim 38 further including means for automatically downloading a multimedia message from said address.

40. The invention of claim 39 wherein said multimedia message is downloaded using Transfer Control Protocol Internet Protocol (TCP/IP).

41. The invention of claim 39 further including means for transferring said multimedia content from one mobile platform to another mobile platform.

42. The invention of claim 41 wherein said means for transferring said multimedia content from one mobile platform to another mobile platform includes means for transferring an address of said content.

43. The invention of claim 39 wherein said applet includes means for playing out said message in accordance with said schedule.

44. The invention of claim 43 further including means for feedback of data relating to said playing out of said message.

45. The invention of claim 44 further including means for generating a transmission report.

46. The invention of claim 24 further including automatically waking said mobile wireless platform.

47. A method for distributing multimedia content to a mobile wireless platform including the steps of:
receiving said multimedia content;
automatically transmitting said content; and
automatically receiving, storing and playing out said content on said mobile wireless platform.

48. A method for advertising including the steps of:
transmitting multimedia ads via a network;
receiving and storing said ads on a device; and
playing back said ads at a predetermined time.

49. The invention of claim 48 including the step of delaying the predetermined time under certain conditions.

50. The invention of claim 49 wherein one of said conditions is a use of said device by a user.

51. The invention of claim 48 further including the step of waking up said device from a low power state.

52. The invention of claim 48 further including the step of aggregating said multimedia ads on a server.

53. The invention of claim 48 further including the step of transmitting an applet from said server to said device.

54. The invention of claim 53 wherein said ad is encoded.

55. The invention of claim 54 wherein said ad is compressed.

56. The invention of claim 55 wherein said applet deciphers said ad.

57. The invention of claim 56 wherein said applet retrieves a schedule with a playback time of said ad.

58. The invention of claim 48 further including the step of scheduling the transmission of said ads.

59. The invention of claim 48 further including the step of storing data on said device regarding the outputting of said ads on said device.

60. The invention of claim 59 further including the step of feeding back said stored data to said server regarding the outputting of said ads on said device.
